(19) United States
(12) Patent Application Publication
(10) Pub. No.: US 2007/0117433 A1
(43) Pub. Date: May 24, 2007

(54) POWER SUPPLY CIRCUIT FOR REMOVABLE AUTOMOTIVE INTERIOR SYSTEMS

(76) Inventor: Slobadan Pavlovic, Canton, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/286,504

(22) Filed: Nov. 23, 2005

(51) Int. Cl. H01R 29/00

(52) U.S. Cl. 439/188

(57) ABSTRACT

An electrical power supply system is provided that includes a vehicle interior trim member selectably mountable to a vehicle interior. The trim member includes an electrical load device and a releasable connector for receiving electrical energy for powering the electrical load device. A power supply connector is electrically coupled to a power supply and releasably attachable to the releasable connector. A switching circuit measures an impedance of the electrical supply system and selectively energizes the power supply connector. The releasable connector is connected to the power supply connector when the trim member is selectively mounted to the vehicle and is disconnected from the releasable connector when the trim member is detached from the vehicle. The switching circuit disconnects power to the power supply connector when the impedance is outside of a predetermined range. The switching circuit connects power to the power supply connector when the impedance is within the predetermined range.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates in general to a vehicle interior power supply connections for interior trim members of a vehicle, and more specifically, to a disconnectable power supply circuit for a detachable interior trim member of a vehicle such as a seat.

2. Description of the Related Art

Vehicle interior systems such as passenger seats are removable from a vehicle and/or stowable in the vehicle. Vehicle seats which include electrical load devices such as heating elements or motors for moving portions of the seats require power be supplied to the vehicle seat through an electric connection. Typically the floor area is the only suitable location for making the electrical connection between a power supply connector and a releasable connector incorporated within the vehicle seat. For vehicle seats that are removable, stowable, or pivotable to a tilt forward position, a mating portion of the electrical interconnection must also be detachable to allow the vehicle seat to be removed, stowed, or pivoted fully forward.

In an electrical connection system which automatically connects and disconnects the mating connectors when the vehicle seat is removed from its position, an exposed power supply connector is present when the seat is removed. The exposed electrical contact is susceptible to a short circuit caused by the electrical contacts coming into contact with a foreign object or by a person, in addition to damage caused by impacts to the contact from the person or object. Furthermore, being that the electrical connection to a vehicle seat is typically made at the floor level, an exposed connector may be susceptible to debris and liquids spilled on the floor which may lead to the corrosion or damage to the electrical contact.

### BRIEF SUMMARY OF THE INVENTION

This invention has the advantage of determining whether an electrical connection is made between two connectors of an electrical supply circuit for supplying power to an electric device within an interior trim member of a vehicle. The electrical supply circuit disconnects power to the power supply connector when the system impedance is outside of a predetermined range that indicates that the connectors are disconnected or that the electrical supply circuit has a short circuit fault.

In one aspect of the present invention, an electrical power supply system is provided that includes a vehicle interior trim member selectably mountable to a vehicle interior. The vehicle interior trim member includes an electrical load device and a releasable connector for receiving electrical energy for powering the electrical load device. The releasable connector includes a high impedance element. A power supply connector is electrically coupled to a power supply and is releasably attachable to the releasable connector for supplying electrical energy from the power supply to the electrical load device. A switching circuit measures an impedance of the electrical supply system and selectively energizes the power supply connector. The releasable connector is connected to the power supply connector when the vehicle interior trim member is attached to the vehicle and is disconnected from the releasable connector when the vehicle interior trim member is detached from the vehicle. The switching circuit disconnects power to the power supply connector when the impedance is outside of a predetermined range. The switching circuit provides power to the power supply connector when the impedance is within the predetermined range.

In one aspect of the present invention, an electrical power supply system is provided that includes a vehicle interior trim member selectably mountable to a vehicle interior. The vehicle interior trim member includes an electrical load device and a releasable connector for receiving electrical energy for powering the electrical load device. The releasable connector includes a high impedance element having an impedance within a predetermined range less than an open circuit impedance. A power supply connector is fixedly mounted to the vehicle interior and adapted to be electrically coupled to a power supply. The power supply connector is also releasably attachable to the releasable connector for supplying electrical energy from the power supply to the electrical load device. A switching circuit measures an impedance across the power supply connector and selectively energizes the power supply connector in response to the measured impedance. The releasable connector is connected to the power supply connector when the vehicle interior trim member is selectively attached to the vehicle and is disconnected from the releasable connector when the vehicle interior trim member is selectively detached from the vehicle. The switching circuit disconnects power from the power supply connector when the measured impedance is outside of the predetermined range. The switching circuit connects power to the power supply connector when the measured impedance is within the predetermined range.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a view of a interior compartment of a vehicle illustrating detachable interior trim members according to a preferred embodiment of the present invention.

FIG. 2 is a perspective view of the power supply connector according to a first preferred embodiment of the present invention.

FIG. 3 is a perspective view of the male terminal contacts of the power supply connector according to a first preferred embodiment of the present invention.

FIG. 4a and 4b are perspective views of the releasable connector according to a preferred embodiment of the present invention.

FIG. 5 is an illustration of the connection of the power supply connector and the releasable connection preferred embodiment of the present invention.

FIG. 6 is an electrical schematic of the electrical supply system circuit according to a preferred embodiment of the present invention.

FIG. 7 illustrates a graph of a predetermined impedance range for determining a power supply state according to a preferred embodiment of the present invention.

FIG. 8 illustrates a switching circuit cycle chart in relation to the measured system impedance.

FIG. 9 is a method for powering on and off the power supply connector according to a preferred embodiment of the present invention.

### DETAILED DESCRIPTION OF THE PREFERRED EMBODIMENT

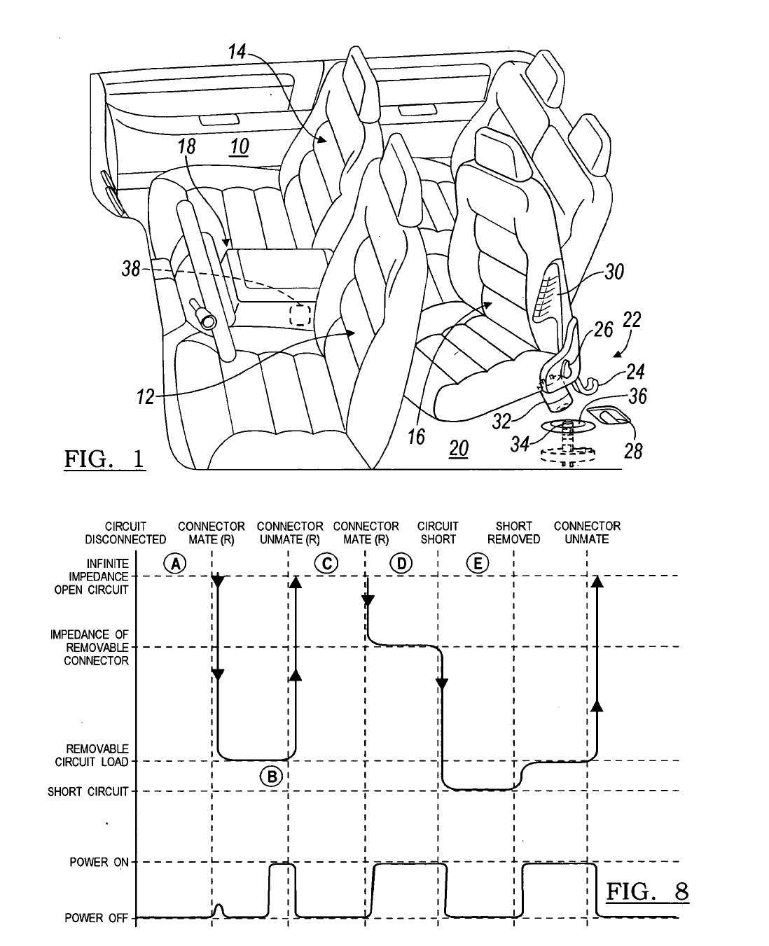

Referring now to the drawings, there is illustrated in FIG. 1 an interior of a vehicle shown generally at 10. The interior of the vehicle 10 includes a driver's seat 12, a front passenger's seat 14, a rear passenger seat 16, and a front center console 18 that are mounted to a vehicle floor shown generally at 20.

The rear passenger seat 16 includes a latch mechanism 22 disposed on a bottom corner of the rear passenger seat 16. The latch mechanism 22 includes a latch 24 and latch release lever 26. The latch mechanism 22 is typically spring-loaded to allow the latch to move into position for engaging a catch 28 mounted in the vehicle floor 20. The latch 24 is unlatched for allowing the rear passenger seat to be moved. For example, the rear passenger seat 16 may be pivoted forward to allow a person access to the rear of the rear passenger seat 16, stowing the rear vehicle seat 16 in a stowable compartment (not shown), or removing the rear passenger seat 16 from the vehicle interior.

The rear passenger seat 16 further includes an electrical load device 30, such as a vehicle seat warmer. The electrical load device 30 may further other types of electrical load devices such as a seat motor for adjusting a backrest or lumbar. A releasable connector 32 is mounted on a bottom portion of the vehicle seat 16 for receiving and supplying power to the electrical load device 30 and is moveable with the rear passenger seat 16 as the seat is moved.

The vehicle floor 20 includes a power supply connector 34 for providing power to the releasable connector 32 when electrically coupled. The power supply connector 34 is fixedly mounted in the vehicle floor 20. Preferably, the power supply connector 34 is recessed below the floor 20 such as in a pilot hole 36. Recessing the power supply connector 34 below the floor 20 prevents the power supply connector 34 from being damaged by impacts.

The releasable connector 32 of the rear vehicle seat 16 is in electrical contact with the power supply connector 34 when rear vehicle seat 16 is in a latched position. As the rear passenger seat 16 is moved to the latch position, the releasable connector 32 extends into the pilot hole 36 and mates the power supply connector 34 recessed below the floor 20. This not only prevents the connection of the power supply connector 34 and the releasable connector 32 from being damaged by contact but also prevents a person or object from contacting the electrical connection when energized.

FIG. 1 further shows an interior trim member such as the front center console 18 that is detachable from the vehicle interior compartment 10. The front center console 18 may include an electrical load device such as a multimedia device (i.e., DVD player for viewing movies or a CD magazine rack for playing audio). The front center console 18 or a portion thereof may be detachable to allow the electrical load device to be removed from the vehicle. The front center console 18 includes an electrical connection, shown generally at 38, that is similar to the electrical connection described above. When the front center console 18 is mounted to the floor 20 or other adjacent structure, an electrical connection is made between the two mating connectors. When the front center console 18 is detached from the floor 20 or other adjacent structure, the center console power supply connector is recessed within the floor 20 to avoid contact or interference with any exterior objects or passengers.

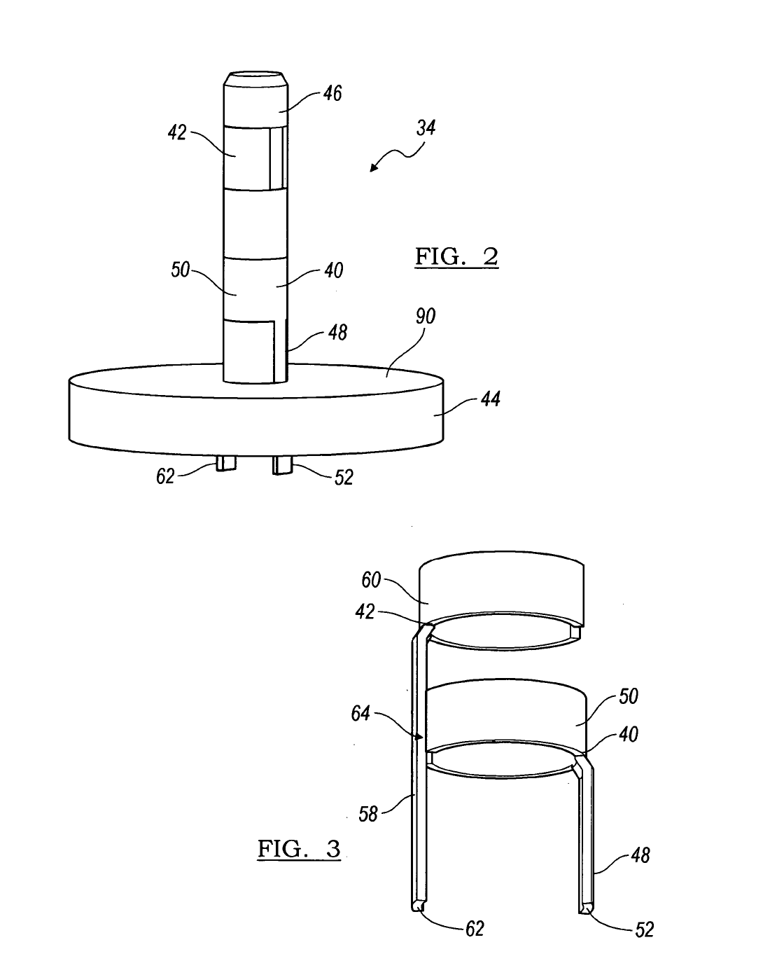

FIG. 2 illustrates a perspective view of the power supply connector 34. The power supply connector 34 includes a first male terminal contact 40 and a second male terminal contact 42 for supplying electrical energy from a power supply device (e.g., vehicle battery) to a female mating connector. The power supply connector 34 includes a circular base portion 44 integrally formed with a guide post 46.

Referring to both FIGS. 2 and 3, the first male terminal contact 40 includes a longitudinal section 48 that is integrally formed to a ring portion 50 that is open ended. The ring portion 50 is retained about the circumference of the post 46. The post 46 may include a notched portion in which the ring portion 50 s inserted therein. Alternatively, the open ended ring portion 50 may be insert-molded as part of the post 46. The longitudinal section 48 extends axially along the post 46 and through the circular base portion 44. An end 52 of the longitudinal section 48 protrudes from a bottom portion the circular base portion 44 for connecting to a wire or harness (not shown) for receiving voltage from the designated power source.

The second male terminal contact 42 includes a longitudinal section 58 that is integrally formed to a ring portion 60 that is open ended. The ring portion 60 is retained about the circumference of the post 46 and is spaced axially in relation to the first ring portion 50. The post 46 may include a notched portion in which the ring portion 60 is inserted therein. Alternatively, the ring portion 60 may be insert-molded as part of the post 46. The longitudinal section 58 extends axially along the post 46 and through the circular base portion 44. An end 62 of the longitudinal section 58 protrudes from the bottom portion of the circular base portion 44 for connecting to a wire or harness (not shown) for receiving voltage from a designated power source.

An open end 64 of the ring portion 50 provides an axial passage for allowing the longitudinal section 58 of the second male terminal contact 42 to extend past the open ended ring portion 50 without contacting and shorting the first male terminal contact 40 to the second male terminal contact 42.

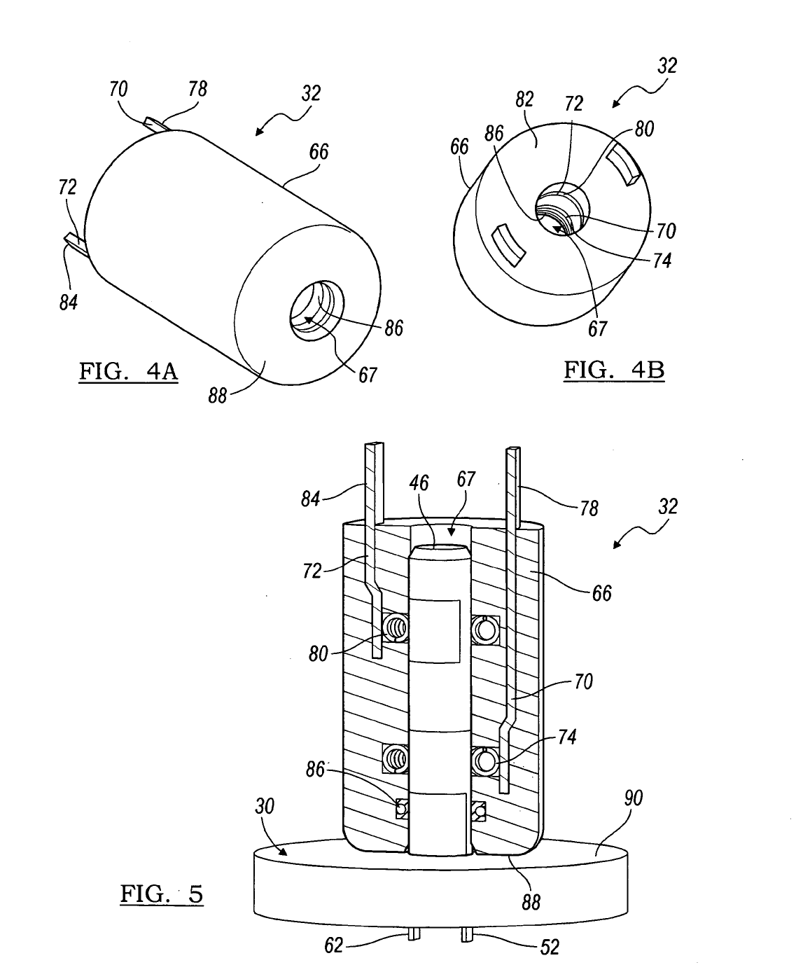

FIGS. 4a and 4b illustrate perspective views of the releasable connector 32. The releasable connector 32 includes a main body 66 made from a nonconductive material. The main body 66 includes an inner bore 67 that extends axially through the main body 66. The releasable connector 32 includes a first female terminal contact 70 that includes a conductive circular member 74 that in electrical contact with a conductive longitudinal member 78. The releasable connector 32 further includes a second female terminal contact 72 which includes a conductive circular member 80 in electrical contact with a conductive longitudinal member 84. The first female terminal contact 70 and second female terminal contact 72 are insert-molded. into the main body 66 and are exposed to the inner bore 67. A circular seal 86 is also insert molded within the main body 66 and exposed to the inner bore 67.

FIG. 5 illustrates the connection between the. releasable connector 32 and the power supply connector 34. The first female terminal contact 70 includes the conductive circular member 74 which is a spring-like member that has radial retention properties for contacting the post 46 when. inserted within the conductive circular member 74. The conductive circular member 74 and the conductive longitudinal member 78 may be integrally formed or may be held in electrical contact with one another by the main body 66. The conductive longitudinal member 78 extends axially within the main body 66. The conductive longitudinal member 78 protrudes through an end surface 82 for electrically coupling to a respective conduit for supplying voltage to the electrical load device 30 within the interior trim member.

The second female terminal contact 72 includes the conductive circular member 80 which is a spring-like member that has retention properties when the post 46 is inserted within the conductive circular member 80. The conductive circular member 80 and the conductive longitudinal member 84 may be integrally formed or may be held in contact with one another by the main body 66. The conductive longitudinal member 84 extends axially within the main body 66. The conductive longitudinal member 84 protrudes through an end surface 82 for electrically coupling to a respective conduit for supplying voltage to the electrical load device within the interior trim member.

The seal 86 is seated within the main body 66 and is exposed to the inner bore 67 near an end portion 88 of the releasable connector 32 for preventing debris from entering the end portion 88 when the power supply connector 30 and the releasable connector 32 are coupled.

The post 46 of the power supply connector 30 positioned on a bottom portion of the rear passenger seat 16 is seated within the bore 67 of the releasable connector 32 when the rear passenger seat 16 is in a secured position to the floor 20. When the post 46 enters the bore 67 from the end portion 88, the post 46 as well as the first and second male terminal contacts 40 and 42 makes contact with the seal 86 as the post 46 moves through the bore 67. As the first and second terminal male contacts 40 and 42 slidingly contact the seal 86, fluid and debris are wiped from each respective contact. As the end portion 88 of the power supply connector 34 bottoms out against a top surface 90 of the circular base portion 44, the first male terminal contact 42 is in electrical contact with the first female terminal contact 70 and the second male terminal contact 42 is in electrical contact with the second female terminal contact 72. Both conductive circular members 74 and 80 exert and inward radial force against the ring portions 50 and 60 for maintaining an electrical connection when the electrical load device 30 is activated. Power is provided to the electrical load device 30 within the rear passenger seat 16 via the mating electrical contacts.

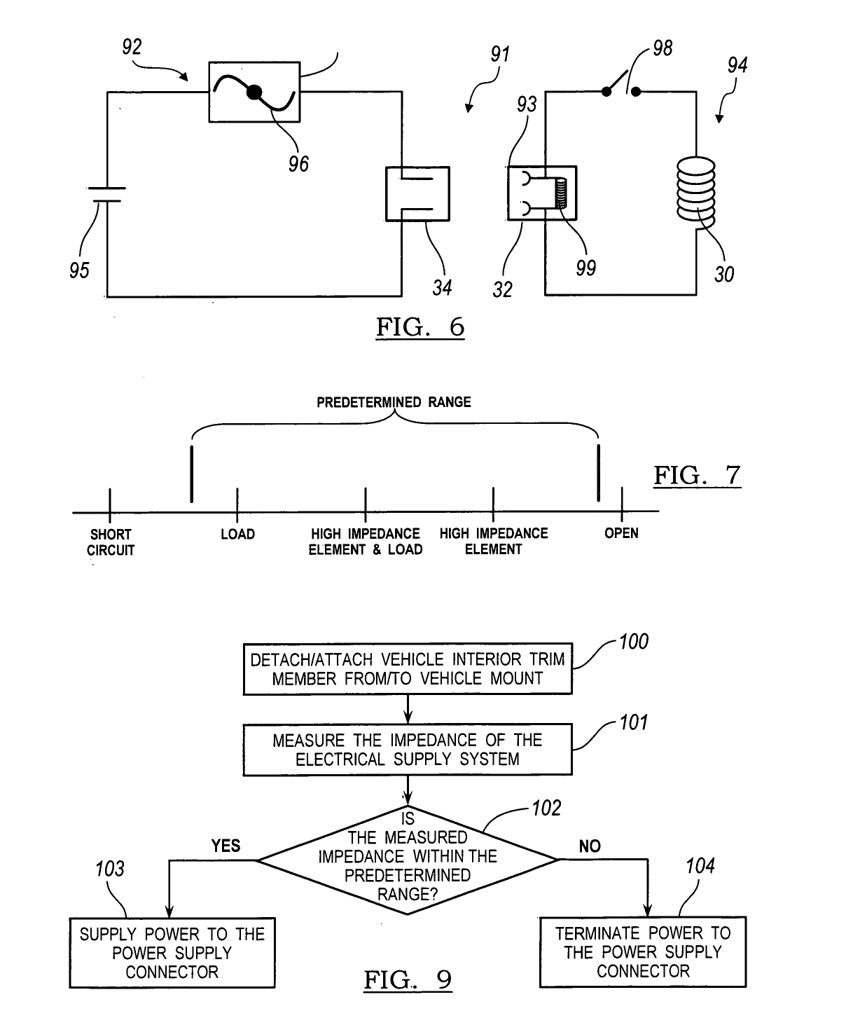

FIG. 6 illustrates a schematic of an electrical supply system 91. The electrical supply system 91 includes a power supply circuit 92 and a releasable supply circuit 94. The power supply circuit 92 includes a power supply source 95, a switching circuit 96, and the power supply connector 34. The power supply source 95 may be an energy storage device such as a battery or an energy generating device such as an alternator. In the preferred embodiment, the power source 95 is electrically connected between the switching circuit 96 and the power supply connector 34. The switching circuit 96 measures an impedance as seen by the switching circuit 96. The switching circuit 96 includes a re-settable controlled switch 97, solid state fuse, or other device which be used connect or disconnect power between the power source 95 and the power supply connector 34. Alternatively the controlled switch 97 or like device may be disposed in a power distribution box (not shown).

The releasable supply circuit 94 includes the releasable connector 32, a device switch 98, and the electrical load device 30. The releasable connector 32 is re-connectable with the power supply connector 34 for receiving power from the power supply circuit 92. The device switch 98 is a power on-off switch which is used to make the electrical connection within the releasable supply circuit 92 for providing electrical energy to the electrical load device 30. The releasable connector 32 also includes a high impedance resistor or other high impedance element 99. This assists in differentiating the impedance of the electrical supply system circuit 91 when the power supply connector 34 and the releasable connector 32 are disconnected in comparison to when the respective connectors are connected but the device switch 97 is open.

FIG. 7 illustrates a range of measured impedances which is used to determine whether power is to be connected to the power supply connector. When the measured impedance value is within a predetermined range, the switching circuit 96 provides power to the power supply connector 34. For measured impedances that are outside of the predetermined range, the switching circuit 96 disconnects power from the power supply connector 34.

The following conditions illustrate occurrences when power is connected or disconnected from the power supply connector 32. A first circuit condition includes the power supply connector 34 being disconnected from the releasable connector 32. This results in an open circuit condition and the total impedance as measured by the switching circuit 96 is an infinite impedance. The infinite impedance is outside of a predetermined range, and as a result, power is disconnected to the power supply connector 34.

A second circuit condition occurs when the power supply connector 34 is connected to the releasable connector 32 and the device switch 98 is closed. The total impedance as measured by the switching circuit 96 includes the impedance of the power supply circuit 92 and the impedance of the releasable supply circuit 94 (e.g., the load) in parallel with element 99. The measured impedance is substantially equal to the load impedance. The predetermined range is set-up to include this impedance level and the switching circuit 96 connects power to the power supply connector 34.

A third circuit condition occurs when the power supply connector 34 is connected to the releasable connector 32 and the switch device 98 is open. The impedance of the electrical load device 30 is not sensed by the switching circuit 96. The measured impedance includes the impedance of the power supply circuit 92 in series with the high impedance element 99. The measured impedance is within the predetermined range and power is connected to the power supply connector. The differentiating factor is the inclusion of the high impedance element 99. In contrast to a circuit that does not utilize the high impedance element 99, the measured impedance as seen by the switching circuit 96 where the respective connectors are connected but the device switch 98 is open would have substantially the same impedance as when the respective connectors are disconnected.

A fourth circuit condition includes a short circuit occurring in the electrical supply circuit 91 while the power supply connector 34 and the releasable connector 32 are connected. The measured impedance by the switching circuit 96 would not include the load of the electrical load device 30 nor the high impedance element 99. The measure impedance (i.e., with the system circuit shorted) would have a low impedance value that is not within the predetermined range. Power to the power supply connector 32 is disconnected.

FIG. 8 illustrates a switching circuit cycle between the power on/off (i.e., power connected/disconnected to the power supply connector) and the measured impedance. Point A illustrates a condition when the circuit is disconnected and there is an open circuit of substantially infinite impedance. The power is disconnected from flowing through the power supply connector during this condition. Point B illustrates the respective connectors connected and the device switch closed. Power flows through the power supply circuit and to the releasable system connector. Point C illustrates the unmating of the connectors. The measured impedance of the electrical supply system is at infinite impedance. Power flowing through the power supply circuit is disconnected. Point D illustrates a condition where the connectors are mated but the device switch is open. Power is provided to the power supply connector. Point E illustrates a short circuit condition. During the short circuit, the measured impedance will not include the load or the high impedance element. The impedance is low and power flowing to the power supply connector is thereby disconnected.

FIG. 9 illustrates a method for powering on and off the power supply connector in response to the measured impedance. In step 100, the vehicle interior trim member is in either the latched or unlatched position. In step 101, the impedance of the electrical supply system is measured. In step 102, a determination is made as to whether the measured impedance is within a predetermined range. If the determination is made that the measured impedance is within a predetermined range, then power to the power supply connector is connected in step 103. If the measured impedance was not within a predetermined range, then power to the power supply connector is disconnected in step 104.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1-13. (canceled)

14. The method of claim 13 wherein said predetermined range corresponds to a total measured impedance of said power supply and said high impedance element.

15. The system of claim 14 wherein said predetermined range corresponds to a total measured impedance of said power supply, said high impedance element, and said electrical load device.

16. The method of claim 10 wherein a switching circuit is coupled between a power supply and said power supply connector for measuring said impedance.

17. The method of claim 17 further comprising a controlled switch for disconnecting power to said power supply connector in response to said switching circuit determining said measured impedance being outside of said predetermined range.

18. The method of claim 18 wherein said controlled switch is disposed within said switching circuit.
